(19) United States
(12) Patent Application Publication
(10) Pub. No.: US 2026/0017067 A1
(43) Pub. Date: Jan. 15, 2026

(54) INFORMATION PROCESSING DEVICE, INFORMATION PROCESSING METHOD, AND COMPUTER-READABLE RECORDING MEDIUM

(71) Applicant: NEC Corporation, Tokyo (JP)

(72) Inventors: Yutaka YAKUWA, Tokyo (JP); Takayuki Kuroda, Tokyo (JP)

(73) Assignee: NEC Corporation, Tokyo (JP)

(21) Appl. No.: 19/256,353

(22) Filed: Jul. 1, 2025

(30) Foreign Application Priority Data
Jul. 12, 2024 (JP) 2024-112881

(51) Int. Cl. G06F 9/4401

(52) U.S. Cl. CPC G06F 9/4411

(57) ABSTRACT

An information processing device includes: a specification determination unit that determines whether a model of a computer system satisfies a specification for configuration elements included in a definition of the model based on self-containment of the configuration elements; and an output unit that outputs a result of the determination as to whether the model of the computer system satisfies the specification.

### CROSS-REFERENCE TO RELATED APPLICATION

This application is based upon and claims the benefit of priority from Japanese patent application No. 2024-112881, filed on Jul. 12, 2024, the disclosure of which is incorporated herein in its entirety by reference.

### TECHNICAL FIELD

The present disclosure relates to a technique for performing automatic design of an information and communication technology (ICT) system and machine learning thereof. In particular, the present disclosure relates to a technique for automating design of an ICT system by causing a computer to calculate a range of the design of the ICT system as a state transition space from a design requirement and a definition of a component to be used, which are declared by humans, and further causing artificial intelligence (AI) to search the state transition space.

### BACKGROUND ART

JP 7036205 B2 discloses a technique for automatically designing an ICT system that satisfies a requirement of a customer. In the technique disclosed in JP 7036205 B2, an abstract element included in an abstract system requirement of the customer are gradually concretized, and a system configuration refined to a deployable level is derived.

In the technique disclosed in JP 7036205 B2, the abstract “system requirement” (hereinafter, also simply referred to as “requirement”) of the customer, a “system configuration proposal” (hereinafter, also simply referred to as “configuration plan”) in the middle of concretizing the system requirement, and a “system concrete configuration” (hereinafter, also simply referred to as “concrete configuration”) in which the system requirement is completely concretized are expressed by data of a graph structure illustrated in FIG. 25. FIG. 25 is a view illustrating an example of a graph structure illustrating the requirement of the ICT system. FIG. 26 is a view illustrating configuration elements included in the requirement of the ICT system illustrated in FIG. 25.

The three of system requirement, system configuration proposal, and system concrete configuration are collectively referred to as a “system configuration” (hereinafter, also simply referred to as “configuration”). A node and an edge that construct the graph structure of the system configuration are referred to as configuration elements. The node means an individual component (for example, a server, a router, or the like) included in the system configuration, and the edge means a relationship (for example, a network connection or the like) between components.

Further, concretization is achieved by rewriting a graph. There may be a plurality of methods of rewriting a graph in relation to the system requirement and the system configuration proposal. The design branches depending on how to rewrite the graph and the order of performing rewriting, and the system concrete configuration to be derived changes. As a result, differences occur in the design, and there are situations in which the design fails (the system requirement, which is an input, is not satisfied) in some cases.

Therefore, in order to perform efficient design using the technique disclosed in JP 7036205 B2, it is important to determine which of the above-described plurality of methods of rewriting a graph is to be implemented and to determine appropriateness or inappropriateness of the order of performing rewriting.

In addition, a technique for determining appropriateness or inappropriateness regarding the content of concretization of the system described above and the order of performing the concretization using reinforcement learning is disclosed in Takashi Maruyama, et al. “Accelerated Search for Search-Based Network Design Generation Scheme with Reinforcement Learning” IEICE Technical Report, vol. 118, no. 483, ICM2018-71, pp. 123-128, March 2019. In general, in reinforcement learning technology, regarding a problem that results to be obtained vary depending on the content and order of actions, various trials are repeatedly performed, and determination on appropriateness or inappropriateness of the content and order of the actions is learned based on rewards obtained according to results of the trials. The reinforcement learning technology has achieved high performance results in learning of Go game AI and the like.

### SUMMARY

Meanwhile, the most important point in automatic design of an ICT system is that a design target is appropriately modeled. However, in the field of automatic design of the ICT system, grammatical specifications of a model have been defined so far, but what is appropriate modeling has not been clearly stated. For this reason, there is a case where the design target is not appropriately modeled, and as a result, the design target cannot be appropriately designed.

When the technique disclosed in Takashi Maruyama, et al. “Accelerated Search for Search-Based Network Design Generation Scheme with Reinforcement Learning” IEICE Technical Report, vol. 118, no. 483, ICM2018-71, pp. 123-128, March 2019 is applied to the technique disclosed in JP 7036205 B2 described above, efficient design of an ICT system can be achieved, but it is difficult to determine whether a design target is appropriately modeled only with these two techniques.

An example of an object of the present disclosure is to make it possible to determine whether a design target is appropriately modeled.

In order to achieve the above object, an information processing device according to one aspect of the present disclosure includes
a specification determination unit that determines whether a model of a computer system satisfies a specification for a configuration element included in a definition of the model based on self-containment of the configuration element, and
an output unit that outputs a result of the determination as to whether the model of the computer system satisfies the specification.

In order to achieve the above object, an information processing method according to one aspect of the present disclosure includes
a specification determination step of determining whether a model of a computer system satisfies a specification for configuration elements included in a definition of the model based on self-containment of the configuration elements, and
an output step of outputting a determination result as to whether a model of the computer system satisfies the specification.

Furthermore, in order to achieve the above object, a computer-readable recording medium according to one aspect of the present disclosure includes a program recorded thereon, the program including
instructions for causing a computer to execute
a specification determination step of determining whether a model of a computer system satisfies a specification for configuration elements included in a definition of the model based on self-containment of the configuration elements, and
an output step of outputting a determination result as to whether a model of the computer system satisfies the specification.

As described above, it is possible to determine whether the design target is appropriately modeled according to the present disclosure.

### BRIEF DESCRIPTION OF THE DRAWINGS

FIG. 1 is a diagram illustrating a state in which branching is repeatedly performed in search processing in automatic design of an ICT system to generate configurations;

FIG. 2 is a diagram illustrating an example in which information included in a configuration of the ICT system is expressed by a graph structure;

FIG. 3 is a view illustrating an example in which information included in the configuration of the ICT system is expressed by text;

FIG. 4 is a view illustrating an example of a format for defining types of configuration elements constituting the ICT system;

FIG. 5 is a view illustrating an example of configuration element type definition information representing definitions of the types of the configuration elements according to the format illustrated in FIG. 4;

FIG. 6 is a diagram illustrating a first example of an expected peripheral configuration for describing self-containment;

FIG. 7 is a diagram illustrating a second example of the expected peripheral configuration for describing the self-containment;

FIG. 8 is a diagram illustrating an example of the expected peripheral configuration for describing the concept of follow;

FIG. 9 is a configuration diagram illustrating a configuration of an example of an information processing device;

FIG. 10 is a flowchart illustrating an example of the overall operation of the information processing device;

FIG. 11 is a flowchart for describing in more detail step S12, illustrated in FIG. 10, of detecting a specification violation;

FIG. 12 is a flowchart for describing in more detail step S113, illustrated in FIG. 11, of checking self-containment of a type of a configuration element;

FIG. 13 is a flowchart for describing step S123, illustrated in FIG. 12, of checking self-containment of an expected peripheral configuration;

FIG. 14 is a flowchart for describing step S133, illustrated in FIG. 13, of checking whether the configuration element is followed by an expected peripheral configuration;

FIG. 15 is a flowchart for describing step S143, illustrated in FIG. 14, of checking whether the expected peripheral configuration is followed by another expected peripheral configuration;

FIG. 16 is a flowchart for describing step S151, illustrated in FIG. 15, of collecting prerequisite configuration elements that cannot be self-established;

FIG. 17 is a flowchart for describing step S163, illustrated in FIG. 16, of checking the possibility of self-establishment of the prerequisite configuration element;

FIG. 18 is a flowchart for describing step S173, illustrated in FIG. 17, of checking whether the prerequisite configuration element is generated from another prerequisite configuration element;

FIG. 19 is a flowchart for describing step S183, illustrated in FIG. 18, of checking whether the prerequisite configuration element is generated from the expected peripheral configuration;

FIG. 20 is a flowchart for describing step S152, illustrated in FIG. 15, of checking whether all the prerequisite configuration elements that cannot be self-established are generated from the expected peripheral configuration;

FIG. 21 is a flowchart illustrating another example of the overall operation of the information processing device;

FIG. 22 is a flowchart for describing step S22 of detecting a specification violation portion of an ICT system model;

FIG. 23 is a flowchart for describing step S213 of checking self-containment of each expected peripheral configuration of the type of the configuration element;

FIG. 24 is a block diagram illustrating an example of a computer that achieves the information processing device;

FIG. 25 is a diagram illustrating an example of a graph structure illustrating a requirement of the ICT system; and

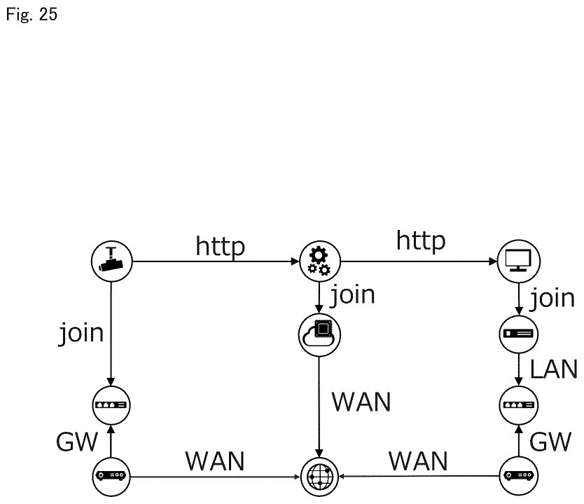

FIG. 26 is a view for describing configuration elements included in a requirement of the ICT system illustrated in FIG. 25.

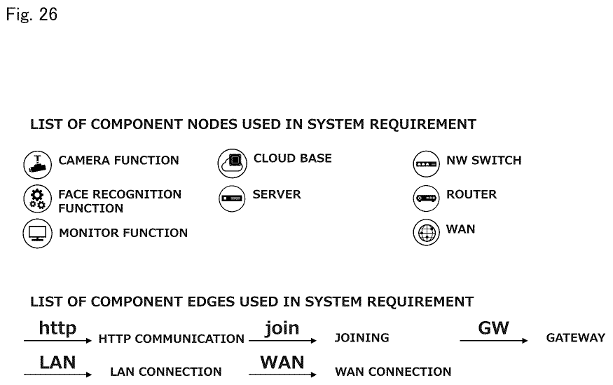

### EXAMPLE EMBODIMENT

### Concept of Present Disclosure

As described above, an object of the present disclosure is to make it possible to determine whether a design target is appropriately modeled in automatic design of an ICT system model, which facilitates modeling of the design target. Furthermore, the object of the present disclosure can be divided into the following Objects 1 to 3, in other words, the object can be finally achieved by achieving Objects 1 to 3.
Object 1 “To ensure that search processing in design based on concretization of a requirement can attain a concrete configuration”
Object 2 “To clarify a condition that needs to be satisfied by a model such that search processing can attain a concrete configuration”
Object 3 “To provide a means for checking whether a given model satisfies the condition”

Details of the above three objects will be described hereinafter.

### [Description of Object 1]

Object 1 “To ensure that search processing in design based on concretization of a requirement can attain a concrete configuration” will be described in detail. First, the meaning of the search processing will be described, and next, the meaning of the fact that search processing can attain a concrete configuration will be described.

### [Description of Search Processing]

Search processing in automatic design of an ICT system is processing of aiming at finding a system concrete configuration while repeating concretization processing of a system configuration proposal and backtracking. The concretization processing includes two kinds of processing: processing of concretizing each configuration element itself to a concrete configuration element for all the configuration elements included in a system configuration; and processing of concretizing the system configuration in such a way as to satisfy an expected peripheral configuration defined for each of the configuration elements. The expected peripheral configuration represents a configuration that needs to be satisfied in the periphery of the configuration element in order for the configuration element to be established, and represents that the configuration element is established by the presence of the expected peripheral configuration. These two kinds of concretization processing and the backtracking are repeatedly executed, and it is determined that design is completed when a concrete configuration has been found.

[Description of Fact that Search Processing Can Attain Concrete Configuration]

The fact that search processing can attain a concrete configuration means that there is a concretization method capable of achieving the concrete configuration satisfying a requirement, the concrete configuration can be always attained by repeating the search, and configuration elements and the requirement obtained by combining the configuration elements are defined for such a purpose. Meanwhile, depending on how to define the configuration elements and the requirement, there is a case where the concrete configuration cannot be attained no matter how the search is repeated, and in such a case, such a model is not appropriate. An object of the present disclosure is to avoid such a case.

If the requirement combining the configuration elements is defined such that the concrete configuration can be attained, design of an ICT system can be completed. However, in practice, it is desirable to define the requirement such that the concrete configuration can be attained even when the design is performed only with the individual configuration elements included in the requirement and their expected peripheral configurations.

The reason is as follows. First, when the requirement is created by combining the configuration elements, it is necessary to examine whether the concrete configuration can be attained by concretizing all the configuration elements including configuration elements added to the system configuration at the time of proceeding with concretization. However, if each of the configuration element is defined such that the concrete configuration can be attained only with the single configuration element and its expected peripheral configuration, it is not necessary to perform the above-described difficult examination.

### [Description of Object 2]

Object 2 “to clarify a condition that needs to be satisfied by a model such that search processing can attain a concrete configuration” will be described in detail. First, the meaning of the model will be described, and next, the condition for enabling attainment of a concrete configuration and concepts necessary for defining the condition will be described. The condition and the concepts are based on new knowledge obtained in the process of examining the present disclosure by the inventors of the present application.

### [Description of Model]

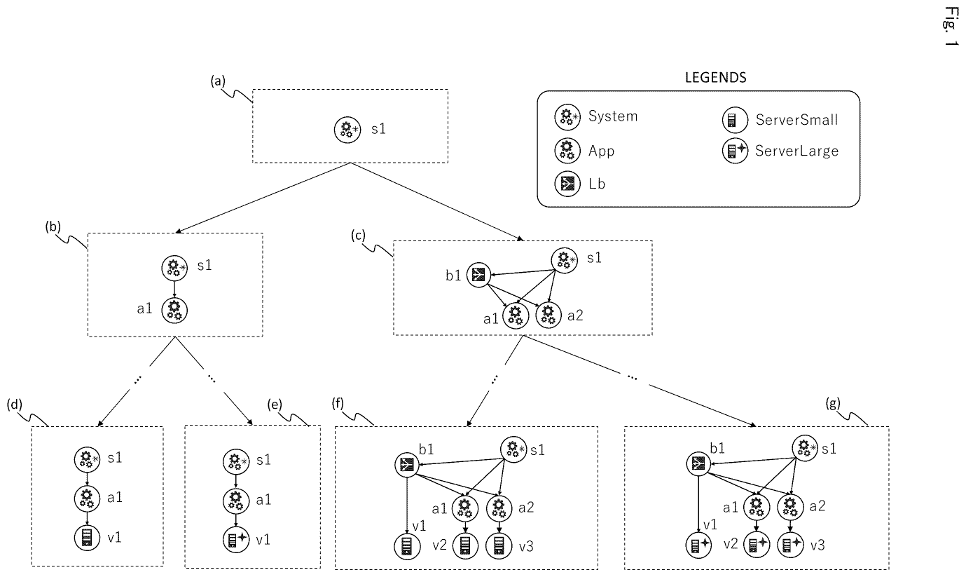

A model used in automatic design of an ICT system defines an abstract element included in a requirement, a concrete element included in a concrete configuration, and a method of concretizing the former to the latter. This model will be described in more detail with reference to FIG. 1. FIG. 1 is a diagram illustrating a state in which branching is repeatedly performed in search processing in the automatic design of the ICT system to generate configurations.

In FIG. 1, (a) to (g) express the configurations, respectively. Each of the configurations includes information of a graph structure indicating a configuration of the ICT system. Among pieces of the information included in the configurations, nodes indicated by circles represent configuration components, and edges indicated by arrows represent relationships between the configuration components. Icons of the nodes represent kinds of the configuration components, and correspondences thereof are illustrated in legends in FIG. 1. Character strings attached to the configuration components represent identifiers of the configuration components. As described above, the configuration components and the relationships between the configuration components are collectively referred to as configuration elements.

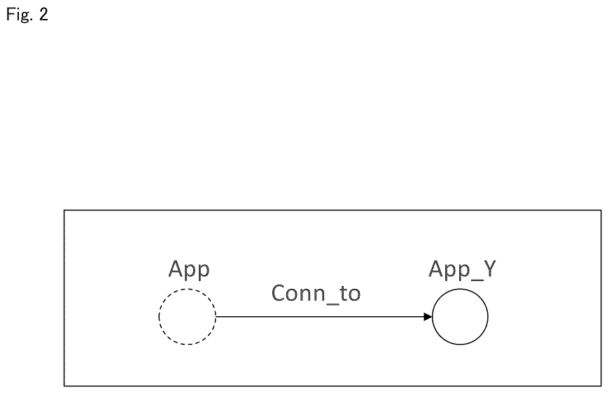

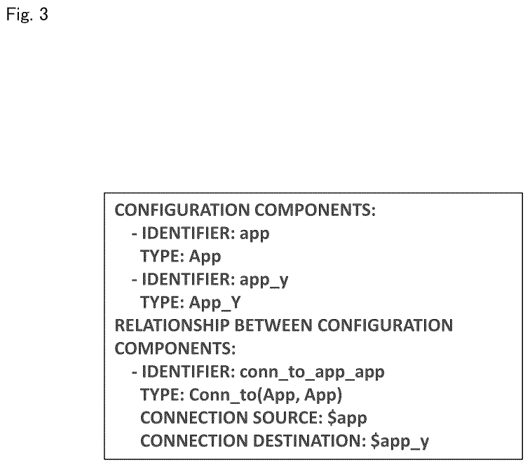

Information included in a configuration may be expressed by text without being limited to examples expressed by the graph structures as illustrated in FIG. 1. An expression method in text is not particularly limited as long as the text can be converted into a unique diagram. For example, a graph structure illustrated in FIG. 2 may be expressed by text illustrated in FIG. 3. FIG. 2 is a diagram illustrating an example in which information included in a configuration of the ICT system is expressed by a graph structure. FIG. 3 is a view illustrating an example in which information included in a configuration of the ICT system is expressed by text.

In the example of FIG. 2, names attached to nodes and an edge indicate type names of configuration components and a relationship, respectively. That is, the graph structure illustrated in FIG. 2 is the configuration representing that concrete application App_Y can communicate with another application App, and expresses that “App and App_Y are connected with a relationship of Conn_to” using the nodes and the edge.

In the example of FIG. 3, the configuration is defined in a text format and includes a list of configuration components and a relationship between configuration components. Each of the configuration components is defined by an identifier for identifying the configuration component and a type of the configuration component. The relationship between configuration components is defined by an identifier for identifying the relationship, a type of the relationship, and identifiers of a connection source configuration component and a connection destination configuration component of the relationship. A symbol “$” illustrated in FIG. 3 indicates that the identifier of a variable name added thereto is referred to. When a definition of an identifier of a certain configuration element is not required due to the reason that it is not referred to in other definition parts of the configuration element, the definition of the identifier may be omitted.

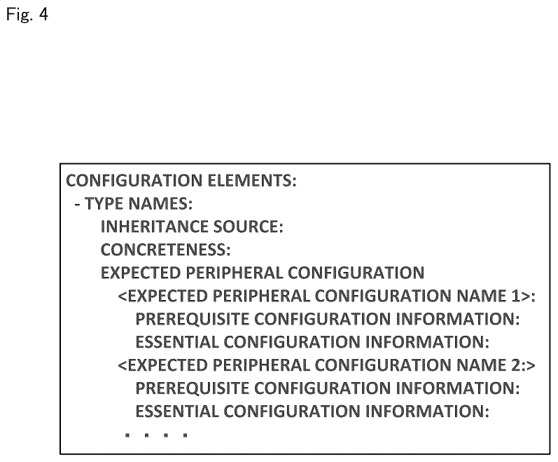

Next, a method of defining a type of a configuration element included in a system configuration will be described. A format for defining a type of a configuration element is illustrated in FIG. 4. FIG. 4 is a view illustrating an example of the format for defining the type of the configuration element constituting the ICT system.

In the type of the configuration element, a name (type name) of the type of the configuration element, an inheritance source, concreteness, and an expected peripheral configuration are specified. The expected peripheral configuration is a configuration expected to be present in the periphery of the configuration element of this type such that the configuration element is present in the system configuration. The type of the configuration element is also referred to as the “configuration element type”. In addition, data or the like defining the configuration element type is also referred to as “configuration element type definition information”.

The inheritance source represents a type of another configuration element inherited by the type of the configuration element, and is not specified when nothing is inherited. It is possible to inherit information of an expected peripheral configuration of the type of the inheritance source by inheriting a type of another configuration component as a configuration component and inheriting a type of another relationship as a relationship. A configuration element of a type that has inherited a certain type is of not only the type of an inheritance destination but also the type of an inheritance source. For example, when an OS type and a Windows type inherited from the OS type are defined, a configuration element of the Windows type is of not only the Windows type but also the OS type.

The concreteness is a flag representing whether the type of the configuration element itself is an abstract configuration element type that can be further concretized or a concrete configuration element type that is not concretized any more. When the concreteness is True, it represents the concrete configuration element type. When the concreteness is False, it represents the abstract configuration element type, and concretization to another configuration element type that inherits the configuration element type is possible.

The expected peripheral configuration represents a configuration that needs to be satisfied in the periphery of the configuration element of the type in order for the configuration element of the type to be established. It represents that the configuration element of the type is established when a configuration described in the expected peripheral configuration is present. For example, it is considered that an OS hosting a certain application is essential for presence of the application, and thus a configuration in which App is hosted by a configuration component of a certain OS type is described in an expected peripheral configuration of a configuration component of an App type representing an application. A plurality of expected peripheral configurations can be defined for one configuration element. If at least one expected peripheral configuration of a certain configuration element is present in a configuration, it is expressed that the expected peripheral configuration of the configuration element is satisfied.

In each expected peripheral configuration, a name of the expected peripheral configuration, a prerequisite configuration, and an essential configuration can be described. The prerequisite configuration is a configuration that is a prerequisite to be concretized in one stage such that the essential configuration to be described later is included in the system configuration. Only in a case where the system configuration in the middle of design includes a configuration described in the prerequisite configuration, the system configuration is concretized in one stage in such a way as to include the essential configuration to be described later. The essential configuration represents a configuration to be included in the system configuration as a result of concretizing the system configuration in one stage (which also includes a case where the configuration is included in the system configuration in advance before concretization). A configuration element included in the prerequisite configuration is also referred to as a “prerequisite configuration element”, and a configuration element included in the essential configuration is also referred to as an “essential configuration element”.

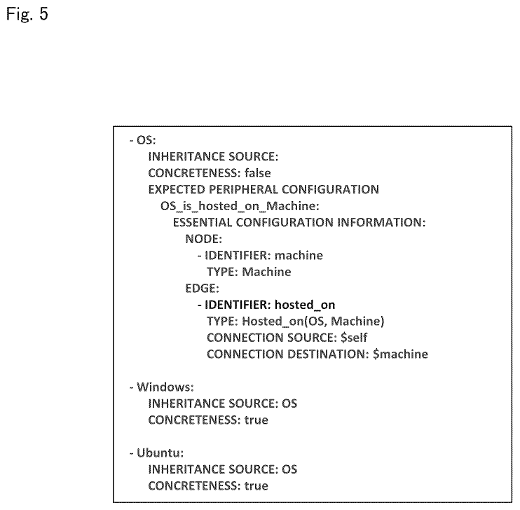

An example of a definition of a configuration element type is illustrated in FIG. 5. FIG. 5 is a view illustrating an example of configuration element type definition information representing a definition of a type of a configuration element in accordance with the format illustrated in FIG. 4. An example of a definition of an OS which is a type of an abstract configuration component representing an operating system and examples of definitions of Windows and Ubuntu which are types that inherit the OS are illustrated in the example of FIG. 5. Since the OS needs to be hosted on a certain Machine in order to be established, it is defined, as an expected peripheral configuration, that a relationship of Hosted_on needs to be established between the OS and the Machine. In addition, configuration components of Windows and Ubuntu, which are concrete OSs, are defined as the types that inherit the OS.

### [Description of Condition for Enabling Attainment of Concrete Configuration and Concepts Necessary for Definition of Condition]

Here, the following will be described as the condition for enabling design of an ICT system model to attain a concrete configuration and concepts necessary for a definition of the condition, and specific examples thereof will be described as necessary.
Self-containment
Follow
Possibility of self-establishment
Generation of configuration element

### [Description of Condition for Enabling Attainment of Concrete Configuration]

In automatic design using a model defined by the above-described method, the condition for enabling search processing to attain a concrete configuration is that “all configuration elements included in a definition of an ICT system model are self-contained”. Therefore, as a specification of the model, “all the configuration elements included in the definition of the ICT system model needs to be self-contained” is defined. A definition of a configuration element being self-contained will be described hereinafter.

### [Description of Self-Containment]

A property called self-containment of a configuration element will be described. The conceptual meaning of self-containment of a configuration element is a property that a concrete configuration can be attained when design is performed only with the configuration element and its expected peripheral configuration. A configuration element having such a property is expressed as a “self-contained configuration element” or that “this configuration element is self-contained”. Conversely, a configuration element that cannot attain a concrete configuration when design is performed only with the configuration element and its expected peripheral configuration is expressed as a “configuration element that is not self-contained” or that “this configuration element is not self-contained”. A condition for a configuration element to be self-contained is that “all expected peripheral configurations of a type of the configuration element are self-contained”. A definition of an expected peripheral configuration being self-contained will be described hereinafter.

A property called self-containment of an expected peripheral configuration will be described. The conceptual meaning of self-containment of an expected peripheral configuration is a property that a concrete configuration can be attained when design is performed only with a configuration element having the expected peripheral configuration and a configuration described only in the expected peripheral configuration. An expected peripheral configuration having such a property is expressed as a “self-contained expected peripheral configuration” or that “this expected peripheral configuration is self-contained”.

Conversely, an expected peripheral configuration that cannot attain a concrete configuration when design is performed only with a configuration element having the expected peripheral configuration and a configuration described in the expected peripheral configuration is expressed as an “expected peripheral configuration that is not self-contained” or that “this expected peripheral configuration is not self-contained”. A condition for an expected peripheral configuration to be self-contained is that “the expected peripheral configuration follows all configuration elements included in the expected peripheral configuration”. A definition of an expected peripheral configuration following a configuration element will be described later.

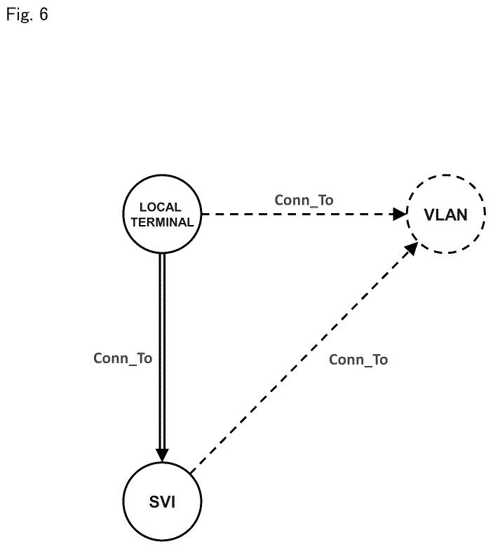

Here, an example of the configuration element that is not self-contained will be described with reference to FIG. 6. FIG. 6 is a diagram illustrating a first example of the expected peripheral configuration for describing the self-containment. In FIG. 6, a double line represents that the expected peripheral configuration is of a type of a configuration element indicated by the double line. Therefore, the example of FIG. 6 illustrates the expected peripheral configuration of a Conn_To type of a relationship between a configuration component of a local terminal type and a configuration component of a switch virtual interface (SVI) type.

A configuration element of a certain type may be simply referred to by a name of the type. For example, the configuration component of the local terminal type may be simply referred to as a local terminal, and the relationship of the Conn_To type may be simply referred to as Conn_To. A single line indicates a prerequisite configuration, and a broken line indicates an essential configuration. That is, in the example of FIG. 6, in a case where the local terminal and the SVI, which are prerequisite configurations, are present as end points of Conn_To, when Conn_To is concretized, a virtual local area network (VLAN) which is an essential configuration is added to a system configuration. The example of FIG. 6 represents the expected peripheral configuration that adds Conn_To, which is an essential configuration, between the local terminal and the VLAN and between the SVI and the VLAN included in the system configuration.

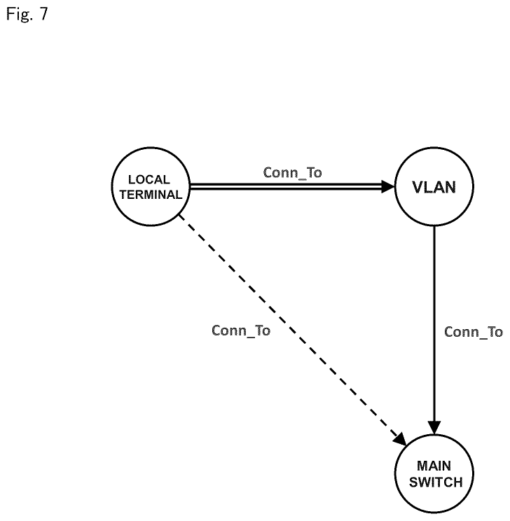

Next, another example of the configuration element will be described with reference to FIG. 7. FIG. 7 is a diagram illustrating a second example of the expected peripheral configuration for describing the self-containment. It is assumed that a certain expected peripheral configuration is defined as illustrated in FIG. 7. The example of FIG. 7 illustrates the expected peripheral configuration of Conn_To (double line) between the local terminal and the VLAN. Conn_To (double line) illustrated in FIG. 7 is added to the system configuration as the essential configuration in the expected peripheral configuration of Conn_To (double line) illustrated in FIG. 6. On the other hand, in the expected peripheral configuration illustrated in FIG. 7, a main switch and Conn_To between the VLAN and the main switch are set as prerequisite configurations in addition to the end points of Conn_To.

Here, the main switch and Conn_To between the main switch and the VLAN described above are not included in the prerequisite configurations or the essential configurations of the expected peripheral configuration in the example of FIG. 6. Meanwhile, in the example of FIG. 6, the expected peripheral configuration of Conn_To between the local terminal and the SVI includes Conn_To between the local terminal and the VLAN, and thus, if concretization of Conn_To between the local terminal and the SVI is advanced, Conn_To between the local terminal and the VLAN also needs to be concretized.

However, in the example of FIG. 6, the main switch and Conn_To between the VLAN and the main switch are set as the prerequisites for the above-described concretization, but are not included in the expected peripheral configuration of Conn_To between the local terminal and the SVI. Then, even if the expected peripheral configuration of Conn_To between the local terminal and the SVI is prepared, a prerequisite configuration necessary for concretizing Conn_To between the local terminal and the VLAN is not prepared only by the prepared expected peripheral configuration. As a result, the design of Conn_To between the local terminal and the SVI cannot be advanced. That is, in the example of FIG. 6, the expected peripheral configuration of Conn_To between the local terminal and the SVI is not self-contained. As can be seen from the examples of FIGS. 6 and 7, the expected peripheral configuration that is not self-contained is a factor that makes it difficult for design to attain a concrete configuration, and thus it is necessary to avoid such modeling.

### [Description of Follow]

An expected peripheral configuration following a configuration element will be described. The conceptual meaning of an expected peripheral configuration following a configuration element is that another configuration element necessary for designing the configuration element is included in the expected peripheral configuration. A condition for an expected peripheral configuration to follow a configuration element is that the “expected peripheral configuration follows one or more of expected peripheral configurations of a type of the configuration element”. A definition of an expected peripheral configuration following another expected peripheral configuration will be described hereinafter.

An expected peripheral configuration following another expected peripheral configuration will be described. The conceptual meaning of an expected peripheral configuration following another expected peripheral configuration is that configuration elements necessary for designing the latter expected peripheral configuration are included in the former expected peripheral configuration. A condition for an expected peripheral configuration to follow another expected peripheral configuration is that “there is no prerequisite configuration element included in the latter expected peripheral configuration, or all prerequisite configuration elements included in the latter expected peripheral configuration satisfy Conditions 1 to 3”.

Condition 1 is that “the prerequisite configuration elements can be self-established in the expected peripheral configuration including the prerequisite configurations”. A definition of the possibility of self-establishment will be described later. Condition 2 is that “the prerequisite configuration elements are included in prerequisite configurations of the former expected peripheral configuration”. The condition 3 is that “the prerequisite configuration elements are generated from the former expected peripheral configuration”. A definition of a configuration element being generated from an expected peripheral configuration will be described later.

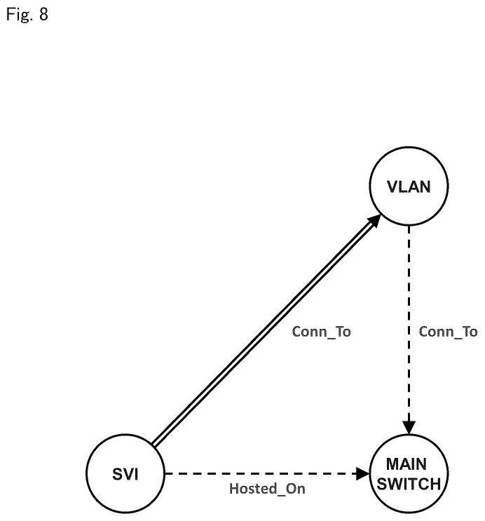

Here, an example in which an expected peripheral configuration follows a configuration element and an expected peripheral configuration of the configuration element will be described. It is assumed that a certain expected peripheral configuration is defined as illustrated in FIG. 8. FIG. 8 is a diagram illustrating an example of the expected peripheral configuration for describing the concept of follow. FIG. 8 illustrates the expected peripheral configuration of Conn_To between the SVI and the VLAN added to the system configuration as an essential configuration due to the expected peripheral configuration of Conn_To illustrated in FIG. 6.

In the expected peripheral configuration illustrated in the example of FIG. 8, when the SVI and the VLAN are present as endpoints of Conn_To, which is a prerequisite configuration, in the peripheral configuration of Conn_To, the main switch, which is an essential configuration, is added to the system configuration. In addition, Conn_To, which is an essential configuration, is added between the VLAN and the main switch in the system configuration. In addition, Hosted_On, which is an essential configuration, is added between the SVI and the main switch in the system configuration. Configurations added as the essential configurations of this expected peripheral configuration includes a configuration corresponding to the prerequisite configuration of the expected peripheral configuration illustrated in FIG. 7.

Therefore, in a case where the expected peripheral configurations are defined as illustrated in FIGS. 6 to 8, although the expected peripheral configuration in FIG. 6 does not include the prerequisite configurations of the expected peripheral configuration in FIG. 7, it is obvious that the prerequisite configurations of the expected peripheral configuration in FIG. 7 are added as the essential configurations of the expected peripheral configuration in FIG. 8, and the design can be advanced without any problem.

In other words, the expected peripheral configuration of FIG. 6 includes configuration elements necessary for designing the expected peripheral configurations of FIGS. 7 and 8. That is, it can be said that the expected peripheral configuration of FIG. 6 follows the expected peripheral configurations of FIGS. 7 and 8. At the same time, it can be said that the expected peripheral configuration of FIG. 6 follows Conn_To between the local terminal and the VLAN having the expected peripheral configuration of FIG. 7 and Conn_To between the SVI and the VLAN having the expected peripheral configuration of FIG. 8.

### [Description of Possibility of Self-Establishment]

The possibility of self-establishment of a prerequisite configuration element will be described. The conceptual meaning of the possibility of self-establishment of a prerequisite configuration element is a property that the prerequisite configuration element can be determined to be obviously present (=the prerequisite can be determined to be established) by the definition of an expected peripheral configuration including the prerequisite configuration element. A prerequisite configuration element having such a property is expressed as a “prerequisite configuration element that can be self-established” or that “this prerequisite configuration element can be self-established”. Conversely, a prerequisite configuration element that cannot be determined to exist obviously is expressed as a “prerequisite configuration element that cannot be self-established” or that “this prerequisite configuration element cannot be self-established”. A condition for a prerequisite configuration element that can be self-established is that “the prerequisite configuration element is generated from any other configuration element included in a prerequisite configuration including the prerequisite configuration element”. A definition of a configuration element being generated from another configuration element will be described later.

### [Description of Generation of Configuration Element]

A configuration element being generated from another configuration element will be described later. The conceptual meaning of a configuration element being generated from another configuration element is that the former configuration element is added to a system configuration as an expected peripheral configuration of the latter configuration element is complemented. However, not only a case where the former configuration element is directly added to the system configuration by complementation of the expected peripheral configuration of the latter configuration element, but also a case where the former configuration element is indirectly added is included.

For example, in a case where a configuration element B is added to a system configuration by complementation of an expected peripheral configuration of a certain configuration element A and a configuration element C is added to the system configuration by complementation of an expected peripheral configuration of the configuration element B, it can be expressed not only that the configuration element C is generated from the configuration element B but also that the configuration element C is generated from the configuration element A.

When a configuration element D is further added to the system configuration by complementation of an expected peripheral configuration of the configuration element C in the above example, it can be expressed that “the configuration element D is generated from the configuration element C”, “the configuration element D is generated from the configuration element B”, and “the configuration element D is generated from the configuration element A”.

As described above, when a certain configuration element is added to the system configuration by performing complementation of an expected peripheral configuration from another configuration element a plurality of times, it is expressed that the latter configuration element is generated from the former configuration element (=the former configuration element generates the latter configuration element). A condition for a configuration element to be generated from another configuration element is that “the former configuration element is added to the system configuration by performing complementation of an expected peripheral configuration from the latter configuration element a plurality of times”.

However, in a case where a means for checking whether the above condition is satisfied is implemented, processing becomes extremely heavy if a part of “the plurality of times” of the above condition is allowed to be any number of times, and thus, it is conceivable to set a limit to an appropriate number of times in practice. This number of times is referred to as the “order of generation”.

A configuration element being generated from an expected peripheral configuration will be described. This concept is similar to the above-described concept of “a configuration element being generated from another configuration element”. The conceptual meaning of a configuration element being generated from an expected peripheral configuration is that the configuration element is added to the system configuration as the expected peripheral configuration is complemented.

However, not only a case where the configuration element is directly added to the system configuration by complementation of the expected peripheral configuration, but also a case where the configuration element is indirectly added is included. For example, in a case where a configuration element A is added to the system configuration by complementation of a certain expected peripheral configuration X and a configuration element B is added to the system configuration by complementation of an expected peripheral configuration Y of the configuration element A, it can be expressed not only that the configuration element B is generated from the expected peripheral configuration Y, but also that the configuration element B is generated from the expected peripheral configuration X. When a configuration element C is further added to the system configuration by complementation of an expected peripheral configuration Z of the configuration element B in the above example, it can be expressed that “the configuration element C is generated from the expected peripheral configuration Z”, “the configuration element C is generated from the expected peripheral configuration Y”, and “the configuration element C is generated from the expected peripheral configuration X”.

As described above, when a certain configuration element is added to the system configuration by performing complementation of a certain expected peripheral configuration a plurality of times, it is expressed that the configuration element is generated from the expected peripheral configuration (=the expected peripheral configuration generates the configuration element). A condition for a configuration element to be generated from an expected peripheral configuration is that “the configuration element is added to the system configuration by performing complementation of the expected peripheral configuration a plurality of times”.

However, in a case where a means for checking whether the above condition is satisfied is implemented, processing becomes extremely heavy if a part of “the plurality of times” of the above condition is allowed to be any number of times, and thus, it is conceivable to set a limit to an appropriate number of times in practice. This number of times is referred to as the “order of generation” similarly to the concept of “a configuration element being generated from another configuration element”.

### [Description of Object 3]

Object 3 “To provide a means for checking whether a given model satisfies the condition” will be described. The means in Object 3 can be provided by a configuration illustrated in the following example embodiments. For this reason, the description of Object 3 is replaced with the following example embodiments.

### First Example Embodiment

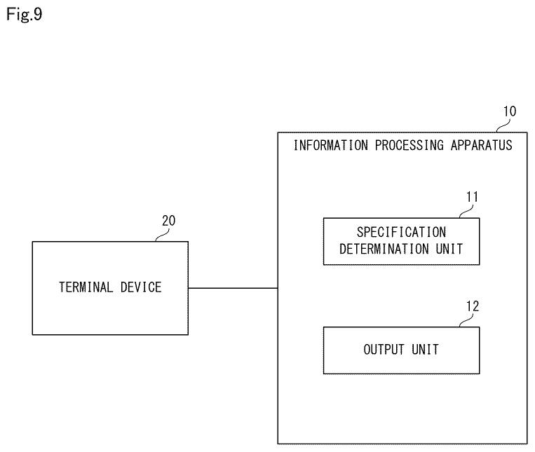

Hereinafter, in a first example embodiment, an information processing device, an information processing method, and a program will be described with reference to FIGS. 9 to 20.

### [Configuration of Device]

First, a configuration of an example of the information processing device will be described with reference to FIG. 9. FIG. 9 is a configuration diagram illustrating the configuration of the example of the information processing device.

An information processing device 10 illustrated in FIG. 9 is a device configured to determine a specification violation in design of a computer system, specifically, an ICT system. As illustrated in FIG. 9, the information processing device 10 includes a specification determination unit 11 and an output unit 12.

The specification determination unit 11 determines whether a model of the computer system satisfies the specification for configuration elements included in a definition of the model based on self-containment of the configuration elements. The output unit 12 outputs a result of the determination as to whether the model of the computer system satisfies the specification.

In this manner, the information processing device 10 can determine whether the model of the designed computer system violates the specification. According to the information processing device 10, it is possible to determine whether a design target is appropriately modeled. As a result, Objects 1 to 3 described above are achieved.

As illustrated in FIG. 9, the information processing device 10 is connected to a terminal device 20 via a network or the like in such a way as to be able to perform data communication. In the example embodiments, an example of the computer system is an ICT system. Hereinafter, the model of the computer system is also referred to as an ICT system model. Specifically, the “specification” is that all the configuration elements included in the definition of the model of the computer system can attain a concrete configuration when design is performed the configuration element and its expected peripheral configuration.

Furthermore, the specification determination unit 11 determines whether the model of the computer system satisfies the specification by determining whether the configuration element is generated from another configuration element or an expected peripheral configuration of the other configuration element. Specifically, the specification determination unit 11 executes determination as to whether a type of the configuration element and a type of an essential configuration element included in the expected peripheral configuration of the other configuration element match within a limit of the number of times determined by the order, and when the types match, the specification determination unit determines that the configuration element is generated from the other configuration element or the expected peripheral configuration of the other configuration element. At this time, the order may be preset, may be randomly set, or may be specified by an input.

### [Operation of Device]

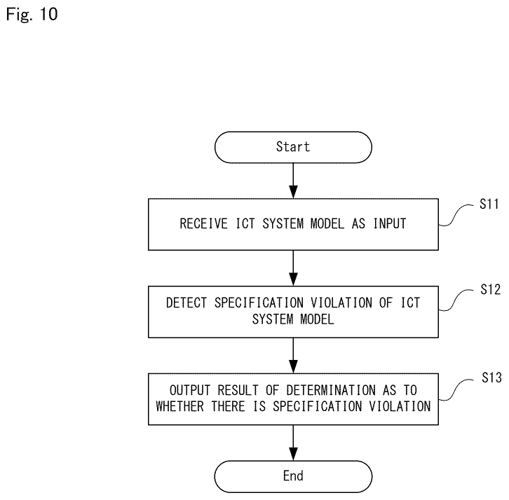

Next, the operation of the information processing device 10 will be described with reference to FIGS. 10 to 20. FIG. 1 will be appropriately referred to in the following description. In the first example embodiment, the information processing method is performed by operating the information processing device 10. Therefore, the description of the information processing method is replaced with the following description of the operation of the information processing device 10.

First, the overall operation of the information processing device 10 will be described with reference to FIG. 10. FIG. 10 is a flowchart illustrating an example of the overall operation of the information processing device.

As illustrated in FIG. 10, first, the specification determination unit 11 receives the ICT system model as the model of the computer system (step S11). Specifically, the specification determination unit 11 receives an input of the ICT system model from the terminal device 20 connected via a network or the like.

Next, the specification determination unit 11 determines whether the ICT system model satisfies the specification for the configuration elements included in the definition thereof based on self-containment of the configuration elements (step S12).

Finally, the output unit 12 outputs a result of the determination in the specification determination unit 11 as to whether the ICT system model satisfies the specification (step S13). An example of an output destination of the determination result is the terminal device 20 on the outside described above.

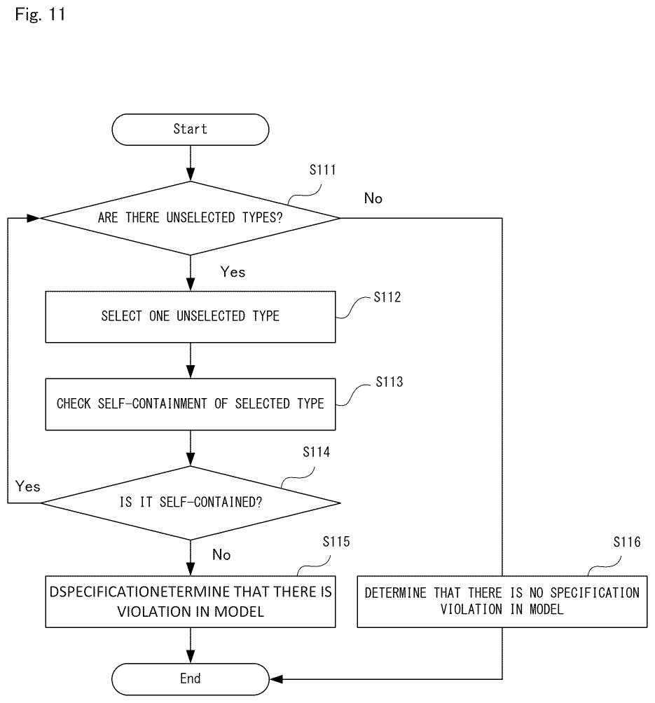

Next, step S12 of detecting a specification violation of the ICT system model will be described in detail with reference to FIG. 11. FIG. 11 is a flowchart for describing step S12 of detecting the specification violation illustrated in FIG. 10 in more detail.

As illustrated in FIG. 11, in step S12, the specification determination unit 11 first determines whether there are unselected types among all types of the configuration elements prepared in advance (step S111). As a result of the determination in step S111, when there are unselected types (step S111: Yes), the specification determination unit 11 selects one unselected type (step S112).

Next, the specification determination unit 11 checks self-containment of the type selected in Step S112 (Step S113). As a result of the checking in step S113, when it is self-contained (step S114: Yes), the specification determination unit 11 returns to step S111.

As a result of the checking in step S113, when it is not self-contained (step S114: No), the specification determination unit 11 determines that there is a specification violation in the ICT system model received in step S11 (step S115), and ends the operation of step S12.

As a result of step S111, when there is no unselected type (step S111: No), the specification determination unit 11 determines that there is no specification violation in the ICT system model received in step S11 (step S116), and ends the operation of step S12.

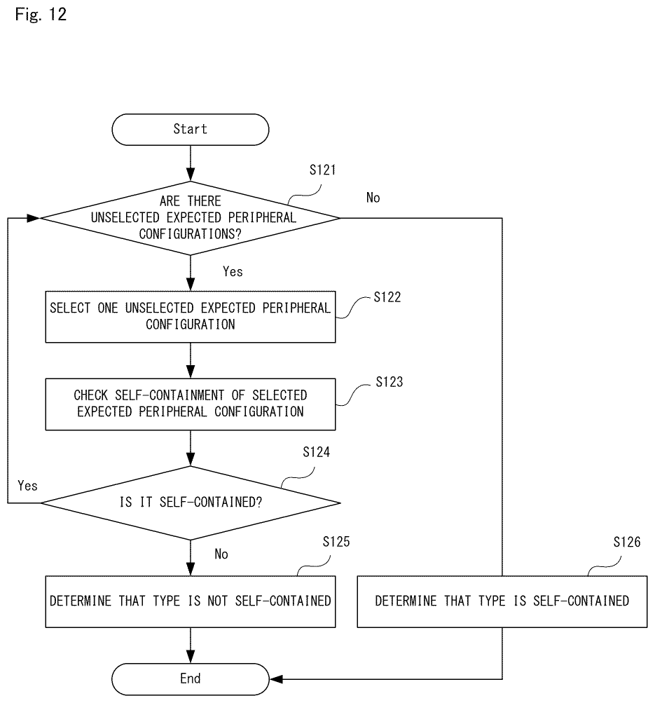

Next, step S113 of checking the self-containment of the type of configuration elements will be described in detail with reference to FIG. 12. FIG. 12 is a flowchart for describing in more detail step S113, illustrated in FIG. 11, of checking the self-containment of the type of configuration elements.

As illustrated in FIG. 12, in step S113, the specification determination unit 11 first determines whether there are unselected expected peripheral configurations of the type selected in step S112 (step S121). As a result of the determination in step S121, when there are unselected expected peripheral configurations (step S121: Yes), the specification determination unit 11 selects one unselected expected peripheral configuration (step S122).

Next, the specification determination unit 11 checks self-containment of the expected peripheral configuration selected in Step S122 (Step S123). As a result of the checking in step S123, when it is self-contained (step S124: Yes), the specification determination unit 11 returns to step S121.

As a result of the checking in step S123, when it is not self-contained (step S124: No), the specification determination unit 11 determines that the type selected in step S112 is not self-contained (step S125), and ends the operation of step S113.

As a result of the determination in step S121, when there is no unselected type (step S121: No), the specification determination unit 11 determines that the type selected in step S112 is self-contained (step S126), and ends the operation of step S113.

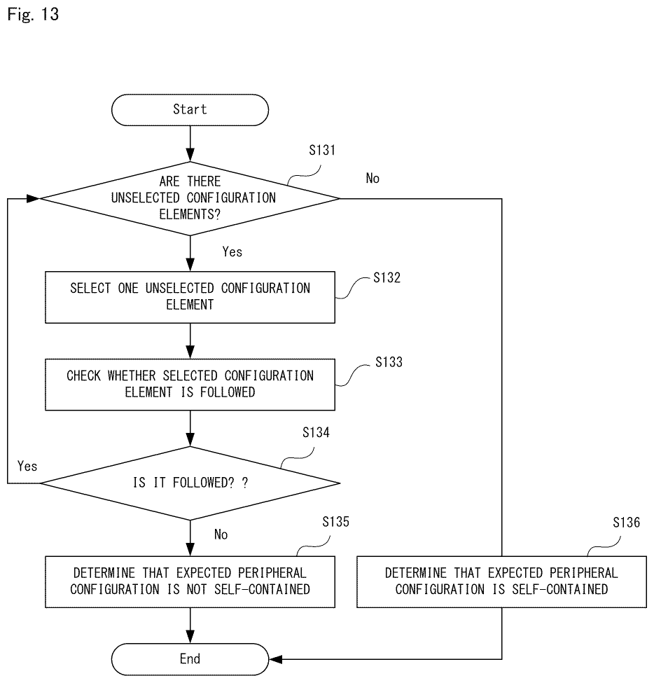

Next, step S123 of checking the self-containment of the expected peripheral configuration will be described in detail with reference to FIG. 13. FIG. 13 is a flowchart for describing step S123, illustrated in FIG. 12, of checking the self-containment of the expected peripheral configuration.

As illustrated in FIG. 13, in step S123, the specification determination unit 11 first determines whether there are unselected configuration elements included in the expected peripheral configuration selected in step S122 (step S131). As a result of the determination in step S131, when there are unselected configuration elements (step S131: Yes), the specification determination unit 11 selects one unselected configuration element (step S132).

Next, the specification determination unit 11 checks whether the configuration element selected in step S132 is followed by the expected peripheral configuration selected in step S122 (step S133). As a result of the checking in step S133, when the configuration element is followed (step S134: Yes), the specification determination unit 11 returns to step S131.

As a result of the checking in step S133, when the configuration element is not followed (step S134: No), the specification determination unit 11 determines that the expected peripheral configuration selected in step S122 is not self-contained (step S135), and ends the operation of step S123.

As a result of the determination in step S131, when there is no unselected configuration element (step S131: No), the specification determination unit 11 determines that the expected peripheral configuration selected in step S122 is self-contained (step S136), and ends the operation of step S123.

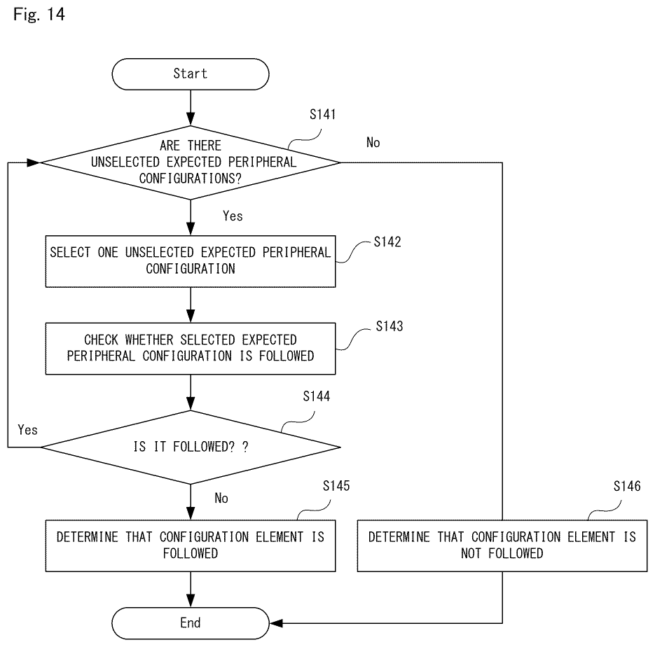

Next, step S133 of checking whether the configuration element is followed by the expected peripheral configuration will be described in detail with reference to FIG. 14. FIG. 14 is a flowchart for describing step S133, illustrated in FIG. 13, of checking whether the configuration element is followed by the expected peripheral configuration.

As illustrated in FIG. 14, first, in step S133, the specification determination unit 11 determines whether there are unselected expected peripheral configurations of the type of the configuration element selected in step S132 (step S141). As a result of the determination in step S141, when there are unselected expected peripheral configurations (step S141: Yes), the specification determination unit 11 selects one unselected expected peripheral configuration (step S142).

Next, the specification determination unit 11 checks whether the expected peripheral configuration selected in step S142 is followed by the expected peripheral configuration selected in step S122 (step S143). As a result of the checking in step S143, when the expected peripheral configuration is not followed (step S144: No), the specification determination unit 11 returns to step S141.

As a result of the checking in step S143, when the expected peripheral configuration is followed (step S144: Yes), the specification determination unit 11 determines that the configuration element selected in step S132 is followed by the expected peripheral configuration selected in step S122 (step S145), and ends the operation of step S133.

As a result of the determination in step S141, when there is no unselected expected peripheral configuration (step S141: No), the specification determination unit 11 determines that the configuration element selected in step S132 is not followed by the expected peripheral configuration selected in step S122 (step S146), and ends the operation of step S133.

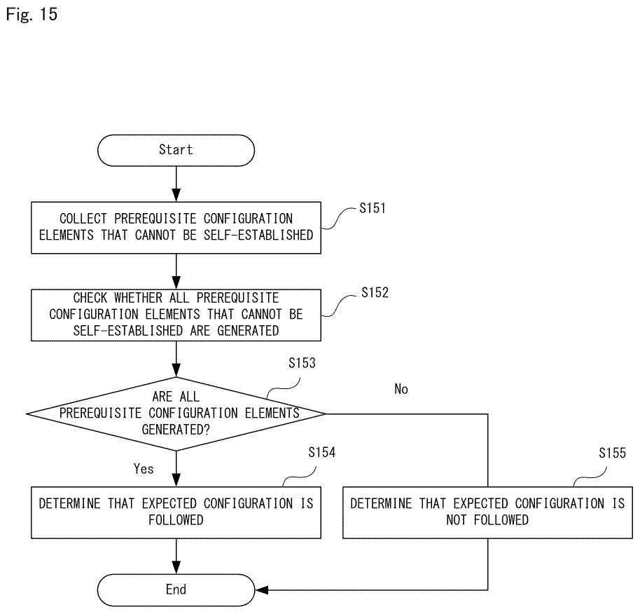

Next, step S143 of checking whether the expected peripheral configuration selected in step S142 is followed by the expected peripheral configuration selected in step S122 will be described in detail with reference to FIG. 15. FIG. 15 is a flowchart for describing step S143, illustrated in FIG. 14, of checking whether the expected peripheral configuration is followed by another expected peripheral configuration.

As illustrated in FIG. 15, in step S143, the specification determination unit 11 first collects prerequisite configuration elements that cannot be self-established among configuration elements included in the expected peripheral configuration selected in step S142 (step S151). Next, the specification determination unit 11 checks whether all the prerequisite configuration elements that cannot be self-established, collected in Step S151, are generated from the expected peripheral configuration selected in Step S122 (Step S152).

As a result of the checking in step S152, when all the prerequisite configuration elements that cannot be self-established, collected in step S151, are generated (step S153: Yes), the specification determination unit 11 determines that the expected peripheral configuration selected in step S142 is followed by the expected peripheral configuration selected in step S122 (step S154), and ends the operation of step S143.

As a result of the checking in step S152, when all the prerequisite configuration elements that cannot be self-established, collected in step S151, are not generated (step S153: No), the specification determination unit 11 determines that the expected peripheral configuration selected in step S142 is not followed by the expected peripheral configuration selected in step S122 (step S155), and ends the operation of step S143.

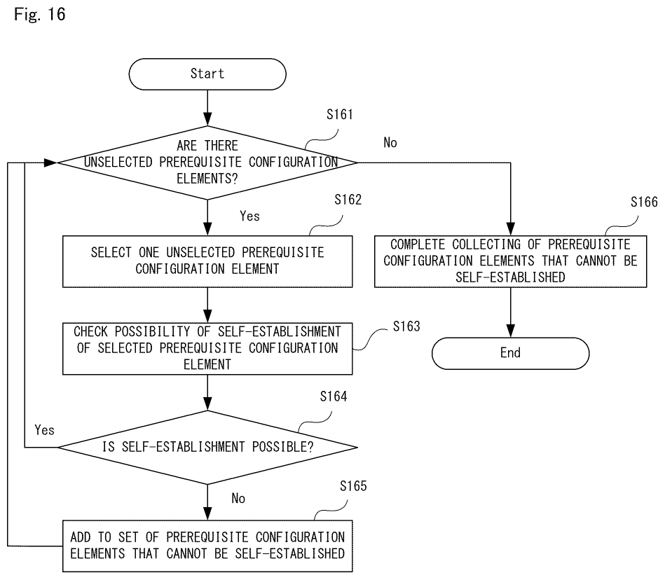

Next, step S151 of collecting the prerequisite configuration elements that cannot be self-established, included in the expected peripheral configuration, will be described in detail with reference to FIG. 16. FIG. 16 is a flowchart for describing step S151, illustrated in FIG. 15, of collecting the prerequisite configuration elements that cannot be self-established.

As illustrated in FIG. 16, in step S151, the specification determination unit 11 first determines whether there are unselected prerequisite configuration elements included in the expected peripheral configuration selected in step S142 (step S161). As a result of the determination in step S161, when there are unselected prerequisite configuration elements (step S161: Yes), the specification determination unit 11 selects one unselected prerequisite configuration element (step S162).

Next, the specification determination unit 11 checks the possibility of self-establishment of the prerequisite configuration element selected in step S162 (step S163). As a result of the checking in step S163, when the self-establishment is possible (step S164: Yes), the specification determination unit 11 returns to step S161.

As a result of the checking in step S163, when the self-establishment is impossible (step S164: No), the specification determination unit 11 adds the prerequisite configuration element selected in step S162 to a set of prerequisite configuration elements that cannot be self-established (step S165), and returns to step S161.

As a result of the determination in step S161, when there is no unselected prerequisite configuration element (step S161: No), the specification determination unit 11 determines that the prerequisite configuration element that cannot be self-established among the configuration elements included in the expected peripheral configuration is currently included in the set of prerequisite configuration elements that cannot be self-established, completes the collection process (step S166), and ends the operation of step S151.

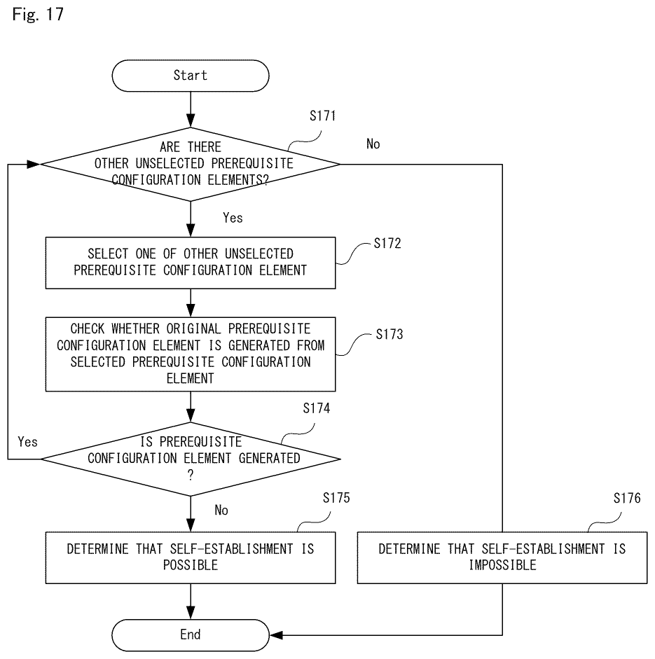

Next, step S163 of checking the possibility of self-establishment of the prerequisite configuration element will be described in detail with reference to FIG. 17. FIG. 17 is a flowchart for describing step S163, illustrated in FIG. 16, of checking the possibility of self-establishment of the prerequisite configuration element.

As illustrated in FIG. 17, in step S163, the specification determination unit 11 first determines whether there are other prerequisite configuration elements that are different from the prerequisite configuration element selected in step S162 and have not been selected in step S172 to be described later (step S171).

As a result of the determination in step S171, when there are other unselected prerequisite configuration elements (step S171: Yes), the specification determination unit 11 selects one of the other unselected prerequisite configuration elements (step S172).

Next, the specification determination unit 11 checks whether the prerequisite configuration element selected in step S162 is generated from the prerequisite configuration element selected in step S172 (step S173). As a result of the checking in step S173, when the prerequisite configuration element is not generated (step S174: No), the specification determination unit 11 returns to step S171.

As a result of the checking in step S173, when the prerequisite configuration element is generated (step S174: Yes), the specification determination unit 11 determines that the prerequisite configuration element selected in step S162 can be self-established (step S175), and ends the operation of step S163.

As a result of the determination in step S171, when there is no unselected prerequisite configuration element (step S171: No), the specification determination unit 11 determines that the prerequisite configuration element selected in step S162 cannot be self-established (step S176), and ends the operation of step S163.

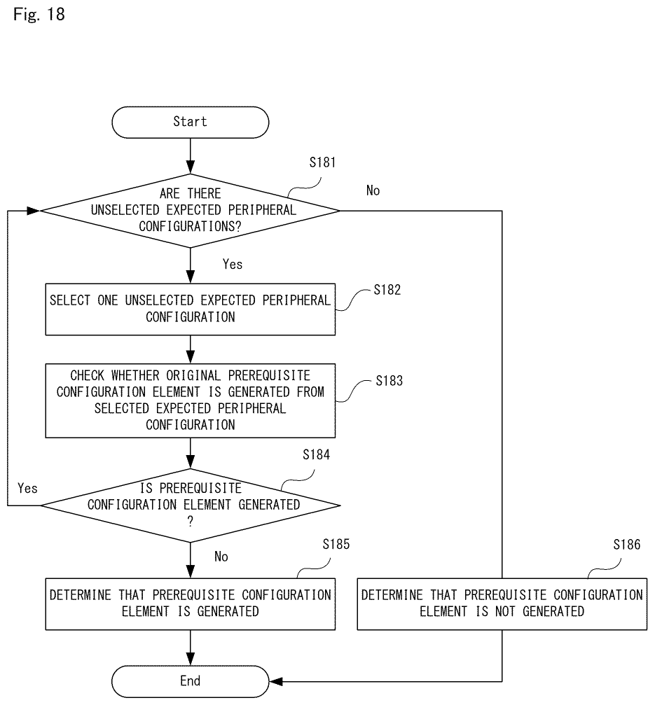

Next, step S173 of checking whether the prerequisite configuration element selected in step S162 is generated from the prerequisite configuration element selected in step S172 will be described in detail with reference to FIG. 18. FIG. 18 is a flowchart for describing step S173, illustrated in FIG. 17, of checking whether the prerequisite configuration element is generated from another prerequisite configuration element.

As illustrated in FIG. 18, in step S173, the specification determination unit 11 first determines whether there are unselected expected peripheral configurations of the prerequisite configuration element selected in step S172 (step S181). As a result of the determination in step S181, when there are unselected expected peripheral configurations (step S181: Yes), the specification determination unit 11 selects one unselected expected peripheral configuration (step S182).

Next, the specification determination unit 11 checks whether the prerequisite configuration element selected in step S162 is generated from the expected peripheral configuration selected in step S182 (step S183). As a result of the checking in step S183, when the prerequisite configuration element is not generated (step S184: No), the specification determination unit 11 returns to step S181.

As a result of the checking in step S183, when the prerequisite configuration element is generated (step S184: Yes), the specification determination unit 11 determines that the prerequisite configuration element selected in step S162 is generated from the prerequisite configuration element selected in step S172 (step S185), and ends the operation of step S173.

As a result of the determination in step S181, when there is no unselected expected peripheral configuration (step S181: No), the specification determination unit 11 determines that the prerequisite configuration element selected in step S162 is not generated from the prerequisite configuration element selected in step S172 (step S186), and ends the operation of step S173.

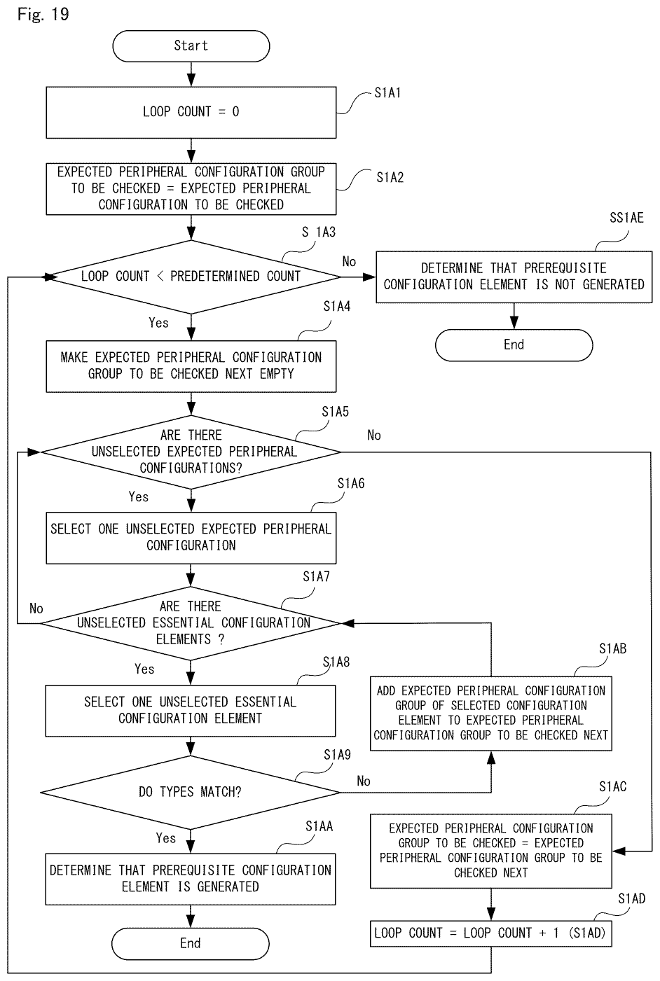

Next, step S183 of checking whether the prerequisite configuration element selected in step S162 is generated from the expected peripheral configuration selected in step S182 will be described in detail with reference to FIG. 19. FIG. 19 is a flowchart for describing step S183, illustrated in FIG. 18, of checking whether the prerequisite configuration element is generated from the expected peripheral configuration.

As illustrated in FIG. 19, first, in step S183, the specification determination unit 11 sets a value of a variable storing a loop count to zero (step S1A1). Next, the specification determination unit 11 sets the content of a variable storing an expected peripheral configuration group to be checked to the expected peripheral configuration selected in step S182 (step S1A2).

Next, the specification determination unit 11 determines whether the loop count is less than a predetermined number (step S1A3). As a result of the determination, when the loop count is less than the predetermined number (step S1A3: Yes), the specification determination unit 11 sets the content of a variable storing an expected peripheral configuration group to be checked next to be empty (step S1A4).

Next, the specification determination unit 11 determines whether there are unselected expected peripheral configurations in the content of the variable storing the expected peripheral configuration group to be checked (step S1A5). As a result of the determination in step S1A5, when there are unselected expected peripheral configurations (step S1A5: Yes), the specification determination unit 11 selects one unselected expected peripheral configuration (step S1A6).

Next, the specification determination unit 11 determines whether there are unselected essential configuration elements in an essential configuration of the expected peripheral configuration selected in step S1A6 (step S1A7). As a result of the determination in step S1A7, when there are unselected essential configuration elements (step S1A7: Yes), the specification determination unit 11 selects one unselected essential configuration element (step S1A8).

Next, the specification determination unit 11 determines whether the essential configuration element selected in step S1A8 matches the type of the prerequisite configuration element selected in step S162 (step S1A9). As a result of the determination in step S1A9, when there is a match (step S1A9: Yes), the specification determination unit 11 determines that the prerequisite configuration element selected in step S162 is generated from the expected peripheral configuration selected in step S182 (step S1AA), and ends the operation of step S183.

On the other hand, as a result of the determination in step S1A9, when there is no match (step S1A9: No), the specification determination unit 11 adds an expected peripheral configuration group of the essential configuration element selected in step S1A8 to the variable storing the expected peripheral configuration group to be checked next (step S1AB), and returns to step S1A7.

As a result of the determination in step S1A7, when there is no unselected configuration element (step S1A7: No), the specification determination unit 11 returns to step S1A5.

Furthermore, as a result of the determination in step S1A5 described above, when there is no unselected expected peripheral configuration in the content of the variable storing the expected peripheral configuration group to be checked (step S1A5: No), the specification determination unit 11 replaces the content of the variable storing the expected peripheral configuration group to be checked with the content of the variable storing the expected peripheral configuration group to be checked next (step SIAC).

Next, after step S1AC is executed, the specification determination unit 11 increases the value of the variable storing the loop count by one (step S1AD), and returns to step S1A3. Then, the specification determination unit 11 executes the determination in step S1A3. As a result, when the loop count is equal to or more than the predetermined number (step S1A3: No), the specification determination unit 11 determines that the prerequisite configuration element selected in step S162 is not generated from the expected peripheral configuration selected in step S182 (step S1AE), and ends the operation of step S183.

The predetermined number referred to in step S1A3 represents the “order of generation”, and a method of determining this value is not limited. For example, the order may be preset as a fixed value in the information processing device 10, or may be a value input by a user of the information processing device 10 at the start of the operation of the information processing device 10.

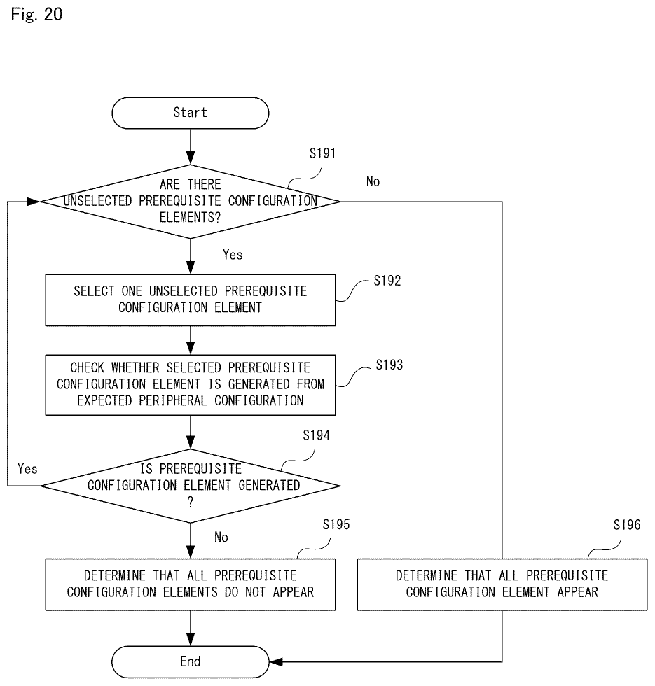

Next, step S152 of checking whether all the prerequisite configuration elements that cannot be self-established, collected in step S151, are generated from the expected peripheral configuration selected in step S122 will be described in detail with reference to FIG. 20. FIG. 20 is a flowchart for describing step S152, illustrated in FIG. 15, of checking whether all the prerequisite configuration elements that cannot self-established are generated from the expected peripheral configuration.

As illustrated in FIG. 20, in step S152, the specification determination unit 11 first determines whether there are unselected prerequisite configuration elements that cannot be self-established collected in step S151 (step S191). As a result of the determination in step S191, when there are unselected prerequisite configuration element (step S191: Yes), the specification determination unit 11 selects one unselected prerequisite configuration element (step S192).

Next, the specification determination unit 11 checks whether the prerequisite configuration element selected in step S192 is generated from the expected peripheral configuration selected in step S122 (step S193). As a result of the checking in step S193, when the prerequisite configuration element is generated (step S194: Yes), the specification determination unit 11 returns to step S191.

As a result of the checking in step S193, when the prerequisite configuration element is not generated (step S194: No), the specification determination unit 11 determines that all the prerequisite configuration elements that cannot be self-established, collected in step S151, are not generated (do not appear) from the expected peripheral configuration selected in step S122 (step S195), and ends the operation of step S152.

In addition, as a result of the determination in step S191 described above, when there is no unselected prerequisite configuration element (step S191: No), the specification determination unit 11 determines that all the prerequisite configuration elements that cannot be self-established, collected in step S151, are generated (appear) from the expected peripheral configuration selected in step S122 (step S196), and ends the operation of step S152.

Step S193 of checking whether the prerequisite configuration element selected in step S192 is generated from the expected peripheral configuration selected in step S122 is performed similarly to step S183 described with reference to FIG. 19. That is, also in step S193, steps S1A1 to S1AD are executed similarly to the example of FIG. 19. For this reason, the detailed description of step S193 is omitted.

### Effects of First Example Embodiment

As described above, in the first example embodiment, it is possible to check whether the ICT system model violates the specification, and it is determined whether it is necessary to correct the ICT system model. Therefore, according to the first example embodiment, it is possible to point out inappropriateness when the ICT system model is not appropriately modeled, and thus, it is easy to appropriately perform design.

### [Program]

The program in the first example embodiment may be any program that causes a computer to execute steps S11 to S13 illustrated in FIG. 10. When the program is installed and executed in the computer, the information processing device and the information processing method according to the first example embodiment can be achieved. In this case, a processor of the computer functions as the specification determination unit 11 and the output unit 12, and performs processing. Examples of the computer include a smartphone and a tablet terminal device in addition to a general-purpose PC.

The program in the first example embodiment may be executed by a computer system constructed by a plurality of computers. In this case, for example, each of the computers may function as either the specification determination unit 11 or the output unit 12.

### Second Example Embodiment

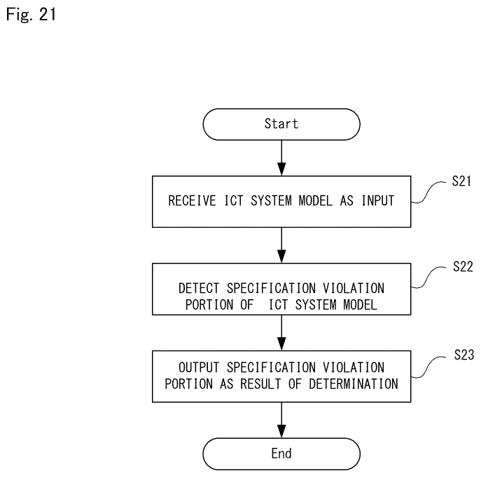

Next, in a second example embodiment, an information processing device, an information processing method, and a program will be described with reference to FIGS. 21 to 23.

### [Configuration of Device]

First, in the second example embodiment, a configuration of the information processing device is similar to the configuration of the information processing device 10 illustrated in FIG. 1. Therefore, FIG. 1 is appropriately referred to in the following description. However, in the second example embodiment, the information processing device 10 is different in a function of the specification determination unit 11.

In the second example embodiment, the specification determination unit 11 detects a portion that does not satisfy a specification in determining whether an ICT system model satisfies the specification. The output unit 12 outputs a determination result including the detected portion. Note that, also in the second example embodiment, the “specification” is that all configuration elements included in a definition of a model of a computer system can attain a concrete configuration when design is performed only with the configuration element and its expected peripheral configuration.

### [Operation of Device]

Next, the operation of information processing device 10 according to the second example embodiment will be described with reference to FIGS. 21 to 23. FIG. 1 will be appropriately referred to in the following description. Also in the second example embodiment, the information processing method is performed by operating the information processing device 10. Therefore, the description of the information processing method is replaced with the following description of the operation of the information processing device 10.

First, the overall operation of the information processing device 10 in the second example embodiment will be described with reference to FIG. 21. FIG. 21 is a flowchart illustrating another example of the overall operation of the information processing device.

As illustrated in FIG. 21, first, the specification determination unit 11 receives the ICT system model as the model of the computer system (step S21). Specifically, the specification determination unit 11 receives an input of the ICT system model from a terminal device or the like connected via a network or the like.

Next, in the second example embodiment, the specification determination unit 11 detects a portion (specification violation portion) where the ICT system model does not satisfy the specification for the configuration elements included in the definition based on the self-containment of the configuration elements (step S22). Specifically, the specification determination unit 11 specifies which type and which expected peripheral configuration of the ICT system model violate the specification, and detects the specified portion as a specification violation portion.

Finally, the output unit 12 outputs information including the specification violation portion detected in step S22 as specification violation information (step S23). The specification violation information is information for specifying which type and which expected peripheral configuration of the ICT system model violate the specification.

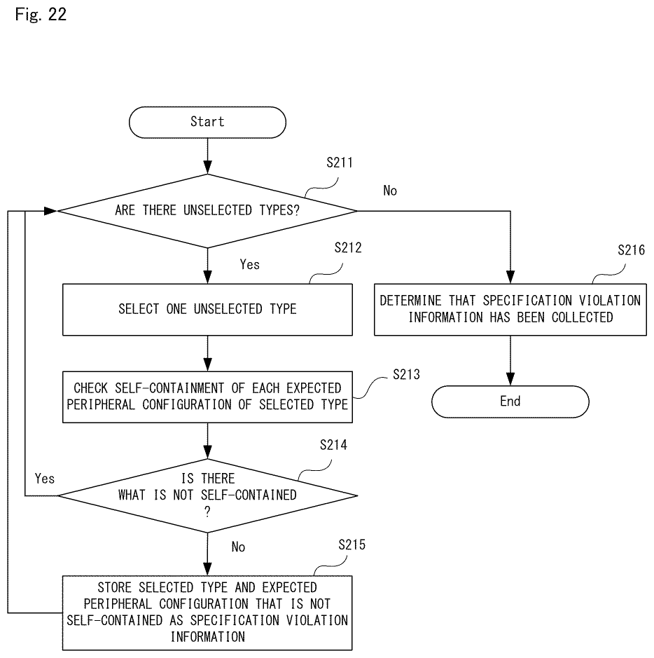

Next, step S22 of detecting the specification violation portion of the ICT system model will be described in detail with reference to FIG. 22. FIG. 22 is a flowchart for describing step S22 of detecting the specification violation portion of the ICT system model.

As illustrated in FIG. 22, first, in step S22, the specification determination unit 11 determines whether there are unselected types among all types of the configuration elements (step S211). As a result of the determination in step S211, when there are unselected types (step S211: Yes), the specification determination unit 11 selects one unselected type (step S212).

Next, the specification determination unit 11 checks self-containment of each of expected peripheral configurations of the type selected in Step S212 (Step S213).

As a result of the checking in step S213, when there is an expected peripheral configuration that is not self-contained (step S214: Yes), the specification determination unit 11 stores the type selected in step S212 and the expected peripheral configuration that is not self-contained, checked in step S213, as the specification violation information (step S215), and returns to step S211.

As a result of the checking in step S213, when there is no expected peripheral configuration that is not self-contained (step S214: No), the specification determination unit 11 returns to step S211.

As a result of the determination in step S211 described above, when there is no unselected type (step S211: No), the specification determination unit 11 determines that the specification violation information of the ICT system model received in step S21 has been collected (step S216), and ends the operation of step S22.

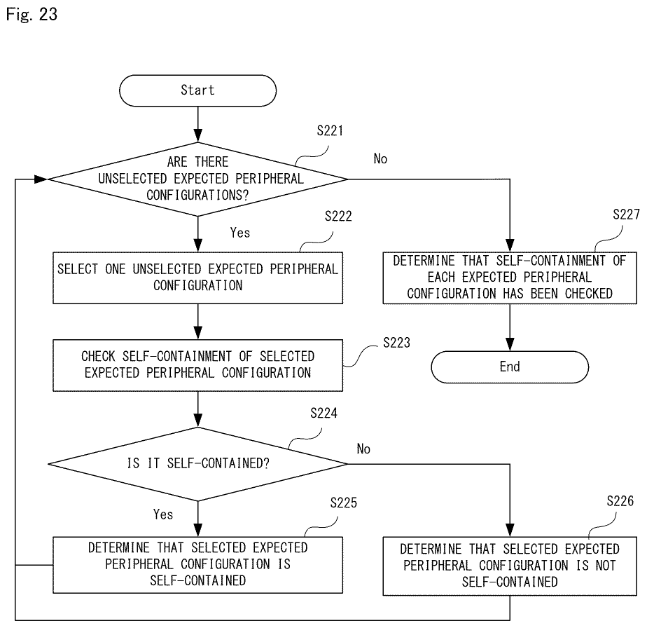

Next, step S213 of checking the self-containment of each of the expected peripheral configurations of the type selected in step S212 will be described in detail with reference to FIG. 23. FIG. 23 is a flowchart for describing step S213 of checking the self-containment of each of the expected peripheral configurations of the type of the configuration elements.

As illustrated in FIG. 23, first, in step S213, the specification determination unit 11 determines whether there are unselected expected peripheral configurations among the expected peripheral configurations of the type selected in step S212 (step S221). As a result of the determination in step S221, when there are unselected expected peripheral configurations (step S221: Yes), the specification determination unit 11 selects one unselected expected peripheral configuration (step S222).

Next, the specification determination unit 11 checks self-containment of the expected peripheral configuration selected in Step S222 (Step S223). The operation of step S223 is similar to the operation of step S123 illustrated in FIG. 12 in the first example embodiment. Since details of step S123 are illustrated in FIG. 13, the description of details of step S223 is omitted.

As a result of the checking in step S223, when the expected peripheral configuration selected in step S222 is self-contained (step S224: Yes), the specification determination unit 11 determines that the expected peripheral configuration selected in step S222 is self-contained (step S225), and returns to step S221.

As a result of the checking in step S223, when the expected peripheral configuration selected in step S222 is not self-contained (step S224: No), the specification determination unit 11 determines that the expected peripheral configuration selected in step S222 is not self-contained (step S226), and returns to step S221.

Thereafter, as a result of the determination in step S221, when there is no unselected expected peripheral configuration (step S221: No), the specification determination unit 11 determines that the self-containment of each of the expected peripheral configurations of the type selected in step S212 has been checked (step S227), and ends the operation of step S213.

### Effects of Second Example Embodiment

As described above, in the second example embodiment, it is possible to check the specification violation portion of the ICT system model. Therefore, according to the second example embodiment, when the ICT system model is not appropriately modeled, such a portion can be presented, and the specification violation can be easily eliminated. As a result, it becomes easy to appropriately perform modeling and design the ICT system model.

### [Program]

A program in the second example embodiment may be any program that causes a computer to execute steps S21 to S23 illustrated in FIG. 21. When the program is installed and executed in the computer, the information processing device and the information processing method according to the second example embodiment can be achieved. In this case, a processor of the computer functions as the specification determination unit 11 and the output unit 12, and performs processing. Examples of the computer include a smartphone and a tablet terminal device in addition to a general-purpose PC.

The program in the second example embodiment may be executed by a computer system constructed by a plurality of computers. In this case, for example, each of the computers may function as either the specification determination unit 11 or the output unit 12.

### [Physical Configuration]

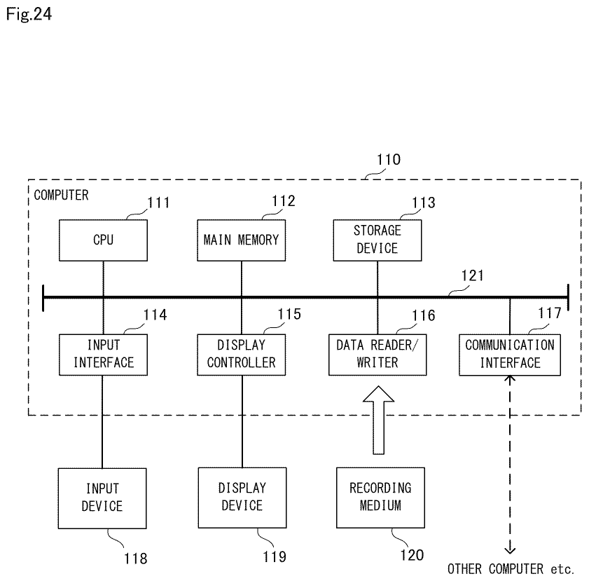

Here, a computer that achieves an information processing device by executing the programs in the first and second example embodiments will be described with reference to FIG. 24. FIG. 24 is a block diagram illustrating an example of the computer that achieves the information processing device.

As illustrated in FIG. 24, a computer 110 includes a central processing unit (CPU) 111, a main memory 112, a storage device 113, an input interface 114, a display controller 115, a data reader/writer 116, and a communication interface 117. These units are connected via a bus 121 in such a way as to be able to perform data communication with each other.

The computer 110 may include a graphics processing unit (GPU) or a field-programmable gate array (FPGA) in addition to the CPU 111 or instead of the CPU 111. In this mode, the GPU or the FPGA can execute the programs according to the example embodiments.

The CPU 111 develops the program according to each of the example embodiments, which is stored in the storage device 113 and includes codes, in the main memory 112, and executes each of the codes in a predetermined order to perform various operations. The main memory 112 is typically a volatile storage device such as a dynamic random access memory (DRAM).

The programs according to the example embodiments are provided in a state of being stored in a computer-readable recording medium 120. The program in each of the present example embodiments may be distributed on the Internet connected via the communication interface 117.

Specific examples of the storage device 113 include a semiconductor storage device such as a flash memory in addition to a hard disk drive. The input interface 114 mediates data transmission between the CPU 111 and input devices 118 such as a keyboard and a mouse. The display controller 115 is connected to a display device 119 and controls display on the display device 119.

The data reader/writer 116 mediates data transmission between the CPU 111 and the recording medium 120, and reads the program from the recording medium 120 and writes a processing result in the computer 110 to the recording medium 120. The communication interface 117 mediates data transmission between the CPU 111 and another computer.

Specific examples of the recording medium 120 include general-purpose semiconductor storage devices such as a compact flash (registered trademark which is abbreviated to CF) and secure digital (SD), a magnetic recording medium such as a flexible disk, and an optical recording medium such as a compact disk read only memory (CD-ROM).

The information processing device can also be achieved by using hardware related to each unit, for example, an electronic circuit, instead of the computer in which the program is installed. Furthermore, a part of the information processing device may be achieved by a program, and the remaining part may be achieved by hardware. In the example embodiments, the computers are not limited to the computer illustrated in FIG. 24.

Some or all of the above-described example embodiments can be expressed by (Supplementary Note 1) to (Supplementary Note 15) described below, but are not limited to the following description.

### Supplementary Note 1

An information processing device including
a specification determination unit that determines whether a model of a computer system satisfies a specification for configuration elements included in a definition of the model based on self-containment of the configuration elements, and
an output unit that outputs a result of the determination as to whether the model of the computer system satisfies the specification.

### Supplementary Note 2

The information processing device according to Supplementary Note 1, wherein
the specification determination unit detects a portion that does not satisfy the specification in the determination as to whether the model of the computer system satisfies the specification, and
the output unit outputs a result of the determination including the detected portion.

### Supplementary Note 3

The information processing device according to Supplementary Note 1, wherein
the specification is that all of the configuration elements included in the definition of the model of the computer system are capable of attaining a concrete configuration when design is performed only with the configuration element and an expected peripheral configuration of the configuration element.

### Supplementary Note 4

The information processing device according to Supplementary Note 3, wherein
the specification determination unit determines whether the model of the computer system satisfies the specification by determining whether the configuration element is generated from another configuration element of the configuration elements or the expected peripheral configuration of the other configuration element.

### Supplementary Note 5

The information processing device according to Supplementary Note 4, wherein
the specification determination unit executes determination as to whether a type of the configuration element and a type of an essential configuration element included in the expected peripheral configuration of the other configuration element match within a limit of the number of times determined by an order, and when the types match, determines that the configuration element is generated from the other configuration element or the expected peripheral configuration of the other configuration element, and
the order is preset, randomly set, or specified.

### Supplementary Note 6

An information processing method including
a specification determination step of determining whether a model of a computer system satisfies a specification for configuration elements included in a definition of the model based on self-containment of the configuration elements, and
an output step of outputting a result of the determination as to whether the model of the computer system satisfies the specification.

### Supplementary Note 7

The information processing method according to Supplementary Note 6, further including,
in the specification determination step, in the determination as to whether the model of the computer system satisfies the specification, detecting a portion that does not satisfy the specification, and,
in the output step, outputting the result of the determination including the detected portion.

### Supplementary Note 8

The information processing method according to Supplementary Note 6, wherein
the specification is that all of the configuration elements included in the definition of the model of the computer system are capable of attaining a concrete configuration when design is performed only with the configuration element and an expected peripheral configuration of the configuration element.

### Supplementary Note 9

The information processing method according to Supplementary Note 8, further including,
in the specification determination step, determining whether the model of the computer system satisfies the specification by determining whether the configuration element is generated from another configuration element of the configuration elements, or the expected peripheral configuration of the other configuration element.

### Supplementary Note 10

The information processing method according to Supplementary Note 9, further including,
in the specification determination step, executing determination as to whether a type of the configuration element and a type of an essential configuration element included in the expected peripheral configuration of the other configuration element match within a limit of a number of times determined by an order, and when the types match, determining that the configuration element is generated from the other configuration element or the expected peripheral configuration of the other configuration element, wherein
the order is preset, randomly set, or specified.

### Supplementary Note 11

A computer-readable recording medium on which a program is recorded, the program including instructions for causing a computer to execute
a specification determination step of determining whether a model of a computer system satisfies a specification for configuration elements included in a definition of the model based on self-containment of the configuration element, and
an output step of outputting a determination result as to whether a model of the computer system satisfies the specification.

### Supplementary Note 12

The computer-readable recording medium according to Supplementary Note 11, wherein,
in the specification determination step, in the determination as to whether the model of the computer system satisfies the specification, a portion that does not satisfy the specification is detected, and,
in the output step, the result of the determination including the detected portion is output.

### Supplementary Note 13

The computer-readable recording medium according to Supplementary Note 11, wherein
the specification is that all of the configuration elements included in the definition of the model of the computer system are capable of attaining a concrete configuration when design is performed only with the configuration element and an expected peripheral configuration of the configuration element.

### Supplementary Note 14

The computer-readable recording medium according to Supplementary Note 13, wherein,
in the specification determination step, whether the model of the computer system satisfies the specification is determined by determining whether the configuration element is generated from another configuration element of the configuration elements, or the expected peripheral configuration of the other configuration element.

### Supplementary Note 15

The computer-readable recording medium according to Supplementary Note 14, wherein
in the specification determination step, determination as to whether a type of the configuration element and a type of an essential configuration element included in the expected peripheral configuration of the other configuration element match is executed within a limit of a number of times determined by an order, and when the types match, it is determined that the configuration element is generated from the other configuration element or the expected peripheral configuration of the other configuration element, and
the order is preset, randomly set, or specified.

As described above, it is possible to determine whether the design target is appropriately modeled according to the present disclosure. The present disclosure is suitably applicable to, for example, creation and correction of a model for automating intelligent work such as a design process of an ICT system.

1. An information processing device comprising:
at least one memory storing instructions; and
at least one processor configured to execute the instructions to:
determine whether a model of a computer system satisfies a specification for configuration elements included in a definition of the model based on self-containment of the configuration elements; and
output a result of the determination as to whether the model of the computer system satisfies the specification.

2. The information processing device according to claim 1,
wherein the one or more processors further detects a portion that does not satisfy the specification in the determination as to whether the model of the computer system satisfies the specification, and
outputs a result of the determination including the detected portion.

3. The information processing device according to claim 1, wherein
the specification is that all of the configuration elements included in the definition of the model of the computer system are capable of attaining a concrete configuration when design is performed only with the configuration element and an expected peripheral configuration of the configuration element.

4. The information processing device according to claim 3,
wherein the one or more processors further determines whether the model of the computer system satisfies the specification by determining whether the configuration element is generated from another configuration element of the configuration elements or the expected peripheral configuration of the other configuration element.

5. The information processing device according to claim 4,
wherein the one or more processors further executes determination as to whether a type of the configuration element and a type of an essential configuration element included in the expected peripheral configuration of the other configuration element match within a limit of a number of times determined by an order, and when the types match, determines that the configuration element is generated from the other configuration element or the expected peripheral configuration of the other configuration element, and
the order is preset, randomly set, or specified.

6. An information processing method that is executed by a computer, the method comprising:
determining whether a model of a computer system satisfies a specification for configuration elements included in a definition of the model based on self-containment of the configuration elements; and
outputting a result of the determination as to whether the model of the computer system satisfies the specification.

7. The information processing method according to claim 6, further comprising:
in the determination as to whether the model of the computer system satisfies the specification, detecting a portion that does not satisfy the specification; and,
in the outputting the result of the determination, outputting the result of the determination including the detected portion.

8. The information processing method according to claim 6, wherein
the specification is that all of the configuration elements included in the definition of the model of the computer system are capable of attaining a concrete configuration when design is performed only with the configuration element and an expected peripheral configuration of the configuration element.

9. The information processing method according to claim 8, further comprising,
in the determination regarding the specification, determining whether the model of the computer system satisfies the specification by determining whether the configuration element is generated from another configuration element of the configuration elements, or the expected peripheral configuration of the other configuration element.

10. The information processing method according to claim 9, further comprising,
in the determination regarding the specification, executing determination as to whether a type of the configuration element and a type of an essential configuration element included in the expected peripheral configuration of the other configuration element match within a limit of a number of times determined by an order, and when the types match, determining that the configuration element is generated from the other configuration element or the expected peripheral configuration of the other configuration element, wherein
the order is preset, randomly set, or specified.

11. A non-transitory computer-readable recording medium on which a program is recorded, the program comprising instructions for causing
a computer to:
determine whether a model of a computer system satisfies a specification for configuration elements included in a definition of the model based on self-containment of the configuration elements; and
output a result of the determination as to whether the model of the computer system satisfies the specification.

12. The non-transitory computer-readable recording medium according to claim 11, wherein,
in the determination as to whether the model of the computer system satisfies the specification, a portion that does not satisfy the specification is detected, and,
in the outputting the result of the determination, the result of the determination including the detected portion is output.

13. The non-transitory computer-readable recording medium according to claim 11, wherein
the specification is that all of the configuration elements included in the definition of the model of the computer system are capable of attaining a concrete configuration when design is performed only with the configuration element and an expected peripheral configuration of the configuration element.

14. The non-transitory computer-readable recording medium according to claim 13, wherein,
in the determination regarding the specification, whether the model of the computer system satisfies the specification is determined by determining whether the configuration element is generated from another configuration element of the configuration elements, or the expected peripheral configuration of the other configuration element.

15. The non-transitory computer-readable recording medium according to claim 14, wherein
in the determination regarding the specification, determination as to whether a type of the configuration element and a type of an essential configuration element included in the expected peripheral configuration of the other configuration element match is executed within a limit of a number of times determined by an order, and when the types match, it is determined that the configuration element is generated from the other configuration element or the expected peripheral configuration of the other configuration element, and
the order is preset, randomly set, or specified.
